(19) United States
(12) Patent Application Publication
(10) Pub. No.: US 2023/0136457 A1
(43) Pub. Date: May 4, 2023

(54) MERITOCRACY-BASED SMART WORKFORCE MANAGEMENT

(71) Applicants: Pranav N. Patel, West Chester, OH (US); SURESH S. IYER, Mason, OH (US); Parth M. PATEL, West Chester, OH (US)

(72) Inventors: Pranav N. Patel, West Chester, OH (US); SURESH S. IYER, Mason, OH (US); Parth M. PATEL, West Chester, OH (US)

(21) Appl. No.: 17/894,135

(22) Filed: Aug. 23, 2022

Related U.S. Application Data
(63) Continuation-in-part of application No. 16/870,947, filed on May 9, 2020, now abandoned.
(60) Provisional application No. 62/846,308, filed on May 10, 2019.

(51) Int. Cl. G06Q 10/10; G06Q 10/1053; G06Q 40/08

(52) U.S. Cl. CPC G06Q 10/103; G06Q 10/1053; G06Q 40/08

(57) ABSTRACT

A meritocracy based smart workforce management platform which ensures ready supply of human resource compliant of project-specific competencies, along with industry-, regulatory-, corporate-defined-, or a combination thereof requirements besides appropriate soft-skills towards accomplishing four vital parameters (1) Cost, (2) Quality, (3) Timeline, and (4) Compliance of an organization. The method selects the candidate based on quality ratings and assigns the trained human resource to the project. The method also incorporates receiving insurance quote based on the profile of a human resource and requirement of a project.

### FIELD OF THE INVENTION

This invention relates to a meritocracy based smart workforce management platform. In particular this invention relates to a meritocracy-based platform which provides better efficiencies to enterprises by eliminating all the administrative tasks associated with identifying talent, on-boarding for a work product, payments, timesheets and performance management.

### RELATED U.S APPLICATION DATA

This application is a continuation-in-part application of Ser. No. 16/870,947 filed on 9 May 2020 which claims the benefit of Provisional application No. 62/846,308, filed on May 10, 2019, which is hereby incorporated by reference in its entirety

### BACKGROUND

In today's society, and in various corporate environments, multi-tasking and efficiency are keys in boosting the bottom line, and ensuring employee optimization and productivity.

Workplaces in general have undergone dramatic changes in order to keep up with customer demands over the last few decades. Furthermore, these changes are facilitating a transition froman industrial age to an information age. Accordingly, new work styles, locations and patterns areunderpinning the changes being experienced in the workplace today, which gives rise to a better connected, more compatible and increasingly complex work environment.

The digital-driven transformation is becoming a norm in all sectors with technologies such as Internet of Things (IoT), cloud computing, and big-data analytics applied in optimizing efficiency in the inputs deployed. Many of the equipment are now cyber-physical systems—engineered systems that integrate information technologies, real-time control subsystems, physical components and human operators to influence physical processes by means of cooperative and semi-automated control functions.

In accordance, there has been an emerging trend of knowledge work, a change of demands for flexible employment contracts that gives rise to leaner organizations, and an increased number of flexible workforces. As such, it is becoming increasingly important for various workplace environments to optimize their workplace culture to include more technology as an important factor that influences and enables the scale of changes within today's workplace.

As such, there is a need for a smart workplace platform that is able to receive multiple projects from an enterprise and select the most qualified candidates efficiently.

In US20030229529 titled, “Method for enterprise workforce planning” provides a solution for identifying one or more persons from a plurality of persons to utilize in achieving a goal. The method comprises establishing competency records, person records, and building desired goal profile records. Competencies identified in person records are compared to required competencies identified in goal profile records to identify best fit persons to utilize in achieving a goal.

In US20010049615 titled, “Method and apparatus for dynamic business management” discusses a method and apparatus for dynamic business management. One embodiment includes a method for workforce procurement and management using a hosted network application. The method comprises maintaining a plurality of modules accessible at varying levels to different participants in a workforce procurement and management process. The modules include: an exchange module comprising a search function; a fulfillment module comprising; a resource management module comprising a work journal function; a knowledge management module comprising a reporting function and an analysis function; and a supplier management module comprising a digital portfolio function. The method includes maintaining a database coupled to the plurality of modules.

While in all the referred prior arts, various automated techniques for selection of apt professionals for a typical work objective on the basis of a plurality of efficiency parameters in a digital platform are described, none takes account of prime management parameters as cost, quality, timeline, compliance and proficiency management into account as well as syncing these with the efficient parameters of the said human resources.

Embodiments of the invention provide significant advantages over prior art systems, through incorporation of the stated management parameters in the selection of optimized human resource in a digital platform, as will now be described.

### BRIEF SUMMARY

For the foregoing reasons, there is a need for a meritocracy-based platform which provides better efficiencies to enterprises by eliminating all the administrative tasks associated with assigning payments, timesheets and performance management, provides candidates projects that closely mirror their skill sets and experience levels while taking into account the quality of work performed in the prior assignments.

In some aspects, a method of selecting one or more eligible candidates from a real time cartesian co-ordinate chart plotted against pay rate VS rating (ΔR chart), is described. An enterprise, company, prospective employer, or another similar entity is suitable for employing this model. The method includes receiving a plurality of candidate profiles stored in a memory. The method includes receiving a set of updated candidate profiles representative of the plurality of candidate profiles, wherein the set of updated candidate profiles comprise a post project notification. The method includes sorting the set of updated candidate profiles based on one or more parameters. The method includes comparing the set of updated candidate profiles to the ΔRchart to determine a list of eligible candidates. The method includes selecting an eligible candidate based on comparing the set of updated candidate profiles to the ΔR chart.

In one embodiment, the method further includes registering the plurality of candidate profiles and the set of updated candidate profiles in an electronic database.

In one embodiment, the one or more parameters include a position of a candidate, a summary of the candidate, an industry, an experience, a field of engineering, educational credentials, a location, one or more skills, and a resume.

In one embodiment, the method further includes registering the plurality of enterprises profiles and set of updated enterprise profiles in an electronic database.

In one embodiment, the post project notification includes one or more enterprise posting a project with one or more key requirements.

In one embodiment, the one or more key requirements include a position of a candidate, a summary of the candidate, an industry, experience, a field of engineering, educational credentials, a location, one or more skills, and a resume.

In one embodiment, the post project notification comprises one or more milestones including a completed status or an in-progress status.

In one embodiment, the project is configured to be sub-divided into periodic tasks.

In one embodiment, the list of eligible clients is displayed on the ΔR chart.

In one embodiment, the method further includes bidding, by one or more candidates, on a project based on a pay rate.

In one embodiment, the rating is a compilation of a candidate's number of years of experience, skill sets, educational credentials, and industry in which candidate has experience, feedback from project history.

In one embodiment, the completed status of a project comprises the steps of: completing one or more daily tasks; approving the one or more daily tasks by an enterprise representative; receiving feedback on the one or more daily tasks; and sending a notification of completion of the milestone.

In one embodiment, the method further includes assigning a list of daily tasks to one or more eligible candidates.

In one embodiment, upon receiving a completion status of one or more daily tasks on the list of daily tasks, one or more of the daily tasks are sent for approval by the client.

In one embodiment, upon the client's approval, the client completes a feedback form.

In one embodiment, the client provides ratings comprising a value on a scale of a highest value and a lowest value.

In one embodiment, the ratings are compiled to provide for an overall rating of the one or more eligible candidates.

In one embodiment, the completion of the one or more daily tasks results in a completed milestone.

In one embodiment, the post project notification is posted upon an enterprise posting a project with one or more key requirements, which can include one or more scanned skills in the project.

In one embodiment, the one or more scanned skills are matched to one or more enterprise listed skills received from the at least one eligible candidate's resume obtained from the memory.

In one embodiment, a notification of the project is posted and sent to the eligible candidates whose skills match the listed skills.

In one embodiment, the method further includes project planning, project management, and splitting the scope of work based on one or more milestones. One or more ratings can be generated from performance management feedback during each milestone that indicate skills, attitude, timely accomplishment, and other similar quality-indicative characteristics; such ratings contribute to the overall ratings for the project.

In one embodiment, on demand dynamic reporting comprising parameters such as spend by regions, spend by department, spend by skills, and spend by skills across multiple regions, etc. is available that pulls information from the memory about projects, cost exposure based on one or more candidates assigned, duration of the projects, etc., performs analytics, and maps to the request.

An aspect of the proposed invention comprises ensuring the ready supply of human resource (i.e., candidate) meets project-specific competency requirements, industry-, regulatory-, corporate-defined-, or a combination thereof compliance requirements, and soft-skills (e.g., attitude, professionalism, communication, etc.) requirements to accomplish at least four vital goals for the project: (1) Cost, (2) Quality, (3) Timeline, and (4) Compliance to a variety of requirements.

In a further aspect of the proposed invention a computer implemented method for optimizing selection and assignment of a human resource (i.e., candidate) to a project is provided, which identifies the project associated with an organization requiring at least one human resource (i.e., candidate) with a set of criteria and availability at a particular time, for a particular duration; the method creates and manages a plurality of user profiles of individuals based on the above criteria, identifies at least one available human resource at the particular time, for the particular duration, closely meeting the mentioned set of criteria; the method further assesses the available human resource options in at least one project-specific critical skill via a computer-generated assessment method; the method also assigns or awards the project to the selected human resource; and also updates the user profiles based on the assessment results.

In an aspect of the invention, the plurality of user profiles includes time durations of availability of candidate to engage in a project, cost bid, and at least one parameter indicating any or a combination of general domain knowledge, behavioral attributes, and compliance knowledge of an individual.

In another aspect of the invention, the set of criteria includes parameters such as but not limited to combination of general domain knowledge, specific expertise, behavioral attributes, and compliance knowledge.

In a further aspect of the invention, the method identifies proficiency levels in each skill that is required by the project and a human resource (i.e., candidate) possesses. The proficiency level can be determined by a variety of methods such as but not limited to the human-resource's self-assessment, verification of credentials (e.g., education, certification, experience, etc.), computer generated assessment, finished learning coursework or experiments, and performance feedback from past engagements. The method then determines at least one expertise, skill characteristic, or feature of each of the human resource within the plurality of human resources, for workforce selection; it further performs a skill/parameters compatibility analysis that provides a compatibility rating of potential human resources from the plurality of human resources; it then identifies a potential human resource for a selected project; it further assesses the selected human resource for requirement gaps; provides training to the selected human resource in areas where gaps are identified from the assessment; it reassesses the trained human resource for updated skills; it then assigns the trained human resource to the project. Each skill of a human-resource is rated and there is an overall rating for the human resource; this rating can be viewed as a composite quality rating.

In an aspect of the invention, such rating can be derived by considering item such as but limited to performance feedback from previously engaged projects, granted certifications, system assigned computer assisted assessment results, and courses taken. The said rating can be finalized by a verification process to build confidence. The verification of a skill proficiency can be performed by verifying credentials (i.e., experiences, education, etc.), computer assisted assessment of skills, searching feedback from previously engaged projects, or a combination thereof.

The stated proficiency management in areas such as, but not limited to, industry, regulatory, legal and corporate compliance can be performed by incorporating local, regional and national resources.

In an aspect of the invention, the stated principles of proficiency management applied for apt human resource selection also allows room for computerized training, frequent/continuous assessment, re-training to assess the resources' workload to estimate and improve utilization, redistribute workload or pull in additional resources to optimize project outcome in terms of quality, time, cost and compliance.

In further aspect of the invention, the financial security of the human resources is ensured through an insurance procurement process with premiums dependent on a composite scale. The said composite scale is based on the scope of the project, quality ratings of the human resources and likewise factors.

In another aspect of the method of the proposed invention, there is a provision of receiving at least one insurance quote based on the profile of a human resource and requirements of a project from at least one insurance underwriter. The human resources can select the best insurance offer for the project and procure the selected insurance. The procurement transaction can take place on the said smart platform/system for available simplicity of the procurement, transparency of work performance, and overall governance to compliance to the terms and conditions

In another aspect of the present invention, the above method is accomplished through a computer system and computer readable medium of program instructions.

In another aspect of the invention, the digitalized system of apt resource identification incorporates a module for insurance procurement based on project scope and quality rating of the candidates. It also allows monitoring of compliance to the terms & conditions of the policy vis-à-vis scope of the project and potential scope changes.

This Summary is provided merely for purposes of summarizing some example embodiments, so as to provide a basic understanding of some aspects of the subject matter described herein.

Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

FIG. 1 depicts a flowchart of the system processes, in accordance with an example;

FIG. 2 depicts a ΔR chart of the system processes, in accordance with an example;

FIG. 3 illustrates key parameter categories that the smart work force management method and system considers according to aspects herein;

FIG. 4 illustrates the quality rating generation for a human resource considering various dimensions such as self-assessment, past experiences, educational credentials, feedback from previous project engagements, verification of credentials, vocational experiences, and knowledge, knowledge assessment, and proficiency management to facilitating selection of a human resource according to aspects of the present disclosure;

FIG. 5 depicts an example embodiment of the key parameters to be taken into account while selecting a human resource;

FIG. 6 is an illustrates an example of selecting human resources by/for different organizations by assessing the resources on various skills, respective proficiency levels and providing relevant training if required;

FIG. 7 depicts a flowchart representing the insurance management according to aspects herein; and

FIG. 8 illustrates a process and system for engaging enterprises, candidates (i.e., human resources), and insurers for various projects deliverables according to various aspects of the present disclosure.

Elements in the figures are illustrated for simplicity and clarity and have not been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Some detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

The invention may be embodied in other specific forms without departing from the spirit of essential characteristics thereof. The present embodiments therefore to be considered in all respects as illustrative and not restrictive, the scope of the invention being indicated by the appended claims rather than by the foregoing description, and all changes which come within the meaning and range of equivalency of the claims are therefore intended to be embraced therein.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The following description is not to be taken in a limiting sense but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases“in one embodiment,” “in an embodiment,” and similar language throughout this specification may, but do not necessarily, all refer to the same embodiment.

The present invention involves a method of selecting one or more eligible candidates from a real time cartesian co-ordinate chart plotted against pay rate VS rating (ΔR chart), is described. The method includes receiving a plurality of candidate profiles stored in a memory. The method includes receiving a set of updated candidate profiles representative of the plurality of candidate profiles, wherein the set of updated candidate profiles comprise a post project notification. The method includes sorting the set of updated candidate profiles based on one or more parameters. The method includes comparing the set of updated candidate profiles to the ΔR chart to determine a list of eligible candidates. The method includes selecting an eligible candidate based on comparing the set of updated candidate profiles to the ΔR chart.

Accordingly, the platform is configured to drive the utilization of the workforce by closely reducing the downtime and enhancing the speed of hiring/contracting by connecting demand to smart supply characteristics.

The system is operable with a plurality of servers and databases that are interconnected via an intranet, internet, network, mobile network, or Wi-Fi based system. Accordingly, the system is built on a smart artificial intelligence system that is configured to autonomously and dynamically learn from commands that are predetermined and implemented by one or more users.

The system is configured to allow enterprises to post their needs for workers with skills in critical fields comprising one or more of budget-based experience, skill levels, and experience levels in years. The smart algorithm is configured to communicate with one or more databases to identify and receive a plurality of candidates that are already registered with the system. An algorithm is utilized that is multivariate which not only takes into account quantitative elements like skill levels, pay levels but also reviews from previous enterprises and the connection with the skill levels in previous jobs. Candidates can then bid for the work, as advertised by the enterprise, chat with prospective enterprises and select on various enterprise provided options for completing one or more of the posted needs or projects.

It is an advantage that the system provides in order to provide for an efficient method to perform administrative activities. The system has an intuitive and simple platform for managing administrative tasks and payments. The payments can be configured to be run through a gateway managed by a payment system that is configured to accept electronic payments comprising credit cards, debit cards, ACH, wire payments, or other similar electronic methods. In addition, timesheets are managed by the candidates, approved online by enterprises, which then triggers the payment request. Once the payment is done, it's split between the candidates and the system seamlessly.

The system is also configured to provide for a reward system. Accordingly, the system provides for an innovative reward system based on length of relationship with the host system, money spent with the system host for enterprises or work product offerors and varied skill levels, experience levels and length of relationship with the candidates. Based on these criteria, for example, the rewards achieved can be as high as 20% for specific cases and dynamically included within the candidate profiles on the platform. The fundamental objective of the algorithm is to provide ideal information for selecting the best candidate, from a pool of candidates, by providing pertinent methodologies to an enterprise for their projects. These methodologies increase the time efficiency and effectiveness in selecting the best candidate for a given project.

Methodologies accumulate data such as skill sets, experience, pay rate and various attributes of a candidate from the knowledge repository. Whenever an enterprise posts a project requiring all of the above accumulated data, the methodologies will help the enterprise in filtering out the list of relevant candidates that align with job parameters. Hence, the resultant list of candidates is plotted on ΔR chart. Accordingly, a synopsis of each and every eligible candidate can be provided. Along with the synopsis, it also helps to provide ranking of a candidate. Above process saves enterprise's time in evaluating each candidate's resume and prioritizing with respect to other candidates.

The system can facilitate the process of evaluating each resume of the eligible candidates. The system is configured to perform screening of each candidate to determine if they meet the qualifications and predetermine parameters as set by the enterprise. The screen includes an extraction of information comprising keywords, phrases, and language within a candidate's resume. The system is further configured to match the extracted information to the project requirements by reading through the resume and notifying the candidates of the matching project, that they can apply to. After an application is submitted, enterprises will receive the applications of eligible candidates that have applied, and are more closely aligned with the enterprises project needs.

For candidate's performance evaluation, multiple tasks can be configured with its own rating periodically. In some instances, the periodic evaluations can be predetermined, or user defined. Accordingly, an enterprise project owner—can be referred as a client—can give feedback on how a candidate (i.e., human resource) has performed for that particular task. In this way, every daily task can have feedback, which helps in identifying any shortcomings in achieving objectives or meeting standards. It provides a platform for both candidates as well as clients to rate aptitude and attitude while they are involved with a project. Hence, it helps to compute overall rating of client as well as candidate. After the evaluation of candidate's performance, client has the opportunity to incentivize candidate's work. The present invention is described by referencing the appended figures representing a preferred embodiment.

Accordingly, through project planning and management, there can be a facilitation of a splitting of the Scope of Work (SoW) via one or more milestones. There can also be a rating assigned to each milestone based on predetermined set criteria, comprising skills, attitude timely, accomplishment, etc. This set criteria can be utilized as performance management feedback that can contribute to an overall rating for the project, comprising of a plurality of milestone ratings. This can help improve productivity of the human resource in delivering intended outcome of the project. This can also help managers efficiently management multiple projects. For example, the managers can utilize a detailed timesheet that allows for a splitting of work that helps in optimizing overall engineering spend within the enterprise through the “pay-by-the-drink” model. Additionally, a robust analytical engine can provide real time reporting of the status of the project, outcome quality, performance of the human resources, costs to the enterprise. The real time reporting can comprise of one or more real time parameters such as spend by skills, spend by region, spend by engineers, overall contractor spending, and other similar parameters or project indicators.

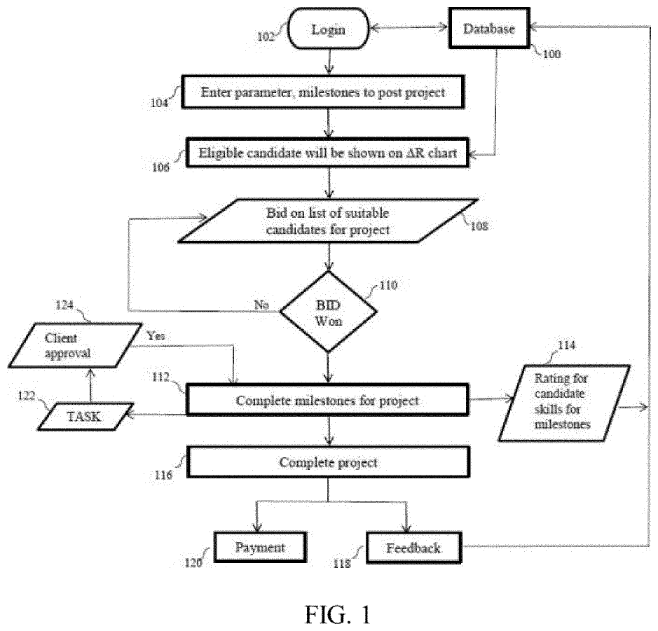

FIG. 1 depicts a flowchart of the system processes. In a first step 100, a candidate needs to access a database through a telephone, internet connection, or a network connection.

Accordingly, a user cannot login 102 into the system unless he has registered with the database. In a next step 104, a user can post a project. When posting a project, specific parameters and milestones related to the project can be included. After all desired details have been entered, the project is posted on the system. Once a project is posted, the list of all eligible candidates aligning to parameters of the project 104 are displayed on ΔR chart 106. The data required for the list of the candidates is accessed from the database 100. Next, the client can analyze each and every individual's profile who are displayed on ΔR chart 106.

After reviewing the profiles, each client can bid 110 on various candidates within a pool of candidates that have applied for the project, or to fill the needs of the enterprise. Whenever a client bids on a candidate, the client receives a notification about the profile of the candidate. The bidding process can be facilitated by an auction module that facilitates bidding and keeps the process business to business (B2B) compliant to the sourcing guidelines of having competitive bids.

Nevertheless, the candidate may not be able to see at what rate the client (e.g., enterprise project owner) has bidded. After reviewing the project profile, a candidate can start his/her own bidding. Meanwhile, the client is able to see each and every bid from various candidates. After reviewing the parameters of the candidates' profiles, the client can move forward with a desired candidate. Once a candidate is selected, s/he can be assigned one or more milestones 112 of the project and associated key performance evaluation parameters.

Each milestone 112 has a rating associated with it which can help to keep track of candidate performance. The candidate can receive performance feedback at each milestone, which provides him/her to sustain or improve his/her performance level. Once the project is completed, candidate can also get feedback on the performance throughout the project. The rating can be a function of ratings from each milestone. Accordingly, the candidate can be paid at each milestone, a predetermined schedule or at the completion based on the specifications and contractual terms.

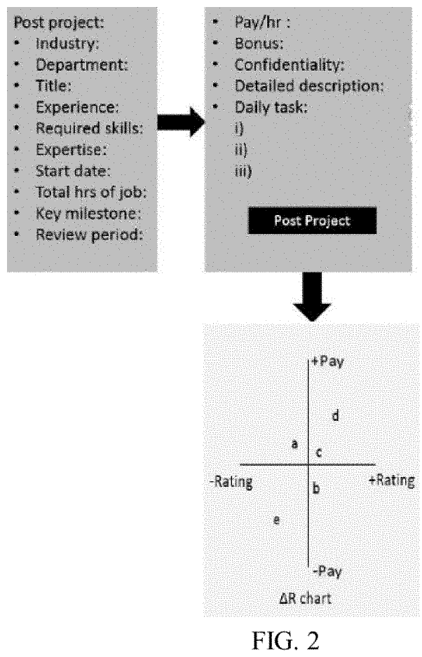

FIG. 2 depicts a view involving a project posted by an enterprise with a select requirements such as industry, department, experience level, expertise, critical skills, salary or pay rate, and detailed description of the project. Accordingly, each of the aforementioned parameters helps in finding relevant candidates. The system pulls all matching profiles from the database and maps eligible candidates on the ΔR chart 106. The ΔR chart is a graph on a two-dimensional Cartesian system in which an x-axis is a rating of the candidate and the y-axis is pay rate.

For example, “a, b, c, d and e” in FIG. 2 can be considered the best suited candidates for a particular job because they close match the requirements. The order in which all the suitable candidates are plotted on the graph is derived by rating each of the candidate and the pay rate at which each candidate is willing to accomplish the project.

Each of a plurality of candidates can also be rated on a predetermined scale. The rating of the candidates is derived by various factors such as, but not limited by, an overall performance of candidate i.e., rating given by other clients to an individual, industry in which an individual has experience, skills set, the number of years of experience, educational credentials, location from where the candidate is willing to work, etc. There can be other parameters to combine with ratings of the one or more candidates and the associated pay rates. Additionally, the ranking of the candidates can be evaluated by one or more of the following: i) 30% Location ii) 20% Bidding Price iii) 20% Overall review of candidate iv) 10% Experience of candidate v) 10% Relevant projects vi) 10% Other parameters clubbed based on overall score rank provided for candidates. In accordance to these rankings, the candidates are evaluated and plotted on the ΔR chart by a formula such as the one following: X1(W1)+X2(W2)+X3(W3)+X4(W4)+X5(W5).

All of the above factors contribute to an overall value which is plotted on the ΔR chart. The position of a candidate is not stagnated on the ΔR chart. The position can change based on the performance rating achieved from the subsequent project engagements.

As described earlier, a project can be divided into various milestones. Each milestone may need to be completed within a certain time frame. Each milestone can be further sub-divided into daily tasks. Once a set of daily tasks and associated outcomes are submitted by a candidate, a milestone may be achieved, subject to approval by the client. Next, a candidate is reviewed in this example by the client for completion of a milestone and is rated on a scale consisting of 5 stars. On this scale, a one star is considered the lowest rating, and five starts is considered the highest rating. that the rating scale can be predetermined or manually set.

All projects that a candidate has worked on are rated and an overall rating is calculated for the candidate. The rating is used for ranking him/her on the ΔR chart.

All of the above processes described, and various variations thereof eliminates the whole time-consuming process which is done after posting a project right from reviewing candidate profiles to compensation/contract-rate negotiation.

Apart from the above objectives, certain other additional objectives may be achieved with the smart workforce management system of the present invention. This may include creating and managing a profile for each candidate/human resource, which may either be an organizational employee or a contract worker, having parameters such as, but not limited to, the ones that identify general domain knowledge in one or more fields, project specific skills, behavioral patterns, industry/regulatory/domain-related compliance knowledge, etc.

The present invention is a system and method of smart workforce management embodying proprietary contents that integrates and utilizes information technologies, includes special purpose subsystems (e.g., special purpose electronics components), and involves human operators from one or more entities.

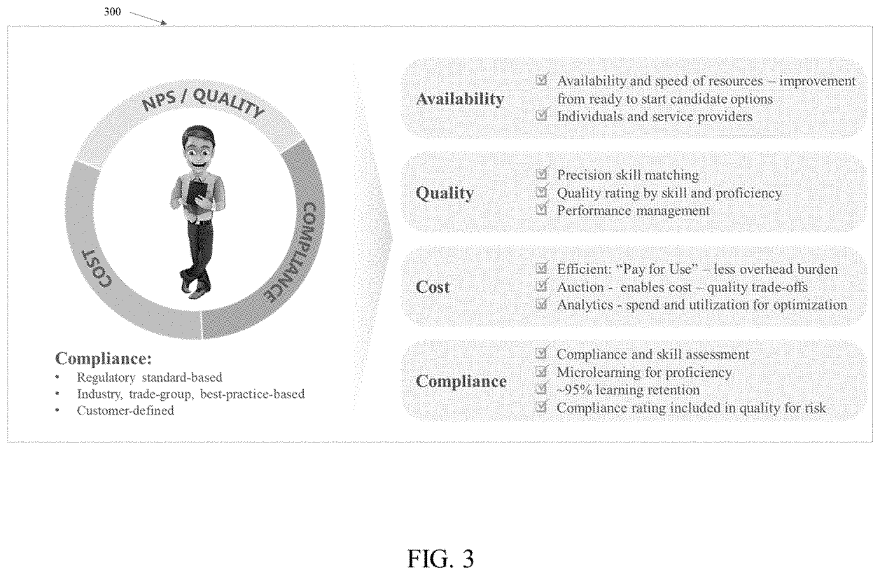

Referring now to the FIG. 3, the said smart workforce management system ensures that key parameter categories 300, such as availability of a human resource at and for desired times, quality of the human resource, cost (or pay rate) of the human resource, and compliance knowledge as well as proficiency level of the human resources, are met according to various aspects of the present disclosure. Enterprises typically struggle to find the best talent (i.e., quality) when they need (i.e., availability), that comply to all internal and external requirements (i.e., compliance) at the best cost; this often leads to productivity losses, quality mishaps, increased liabilities. Quality objectives are achieved in part when the engaged human resource's skills match closely with the project requirements. Corporate liabilities are reduced in part when the human resource is proficient in the desired compliance related knowledge (i.e., industry, regulatory, trade-association, legal, best-practices, or corporate). An enterprise can achieve cost productivity if it can utilize the best fit human resource only for the time it needs (e.g., “pay-for-use”) by reducing overheads.

According to certain aspects herein, the process involves creating an overall score for each of a plurality of human resources—a quality rating—based on parameters that indicate skills and proficiency levels in various areas, and information such as, but not limited to, educational credentials, previous work experiences, project engagement feedback, specific skills, compliance knowledge, and coursework/training in different subject areas from his his/her profile. A rating is assigned to each skill and compliance area to indicate the proficiency level. The proficiency level for each skill and compliance area can be assessed by a variety of methods such as, but not limited to, (a) granted certification(s), (b) feedback from previously engaged projects, (c) system assigned computer-assisted assessment, (d) courses taken, or (d) a combination thereof.

Availability of resources (individuals and/or service providers) at a particular time, at a particular location, and for desired time duration, entails substantial improvement in apt availability of resources in a speedy manner. The skill-/compliance area-level quality parameters and ratings (determined based-on proficiency levels) help in ensuring precision skill matching. Further, the said parameters also function in accordance with the tenets of performance management to enable communication between the client and the human resource in support of accomplishing the strategic objectives of the organization. The “cost” objective can be achieved by enabling the auctioning process in which potential human resources (i.e., candidates) submit their pay-rates (i.e., bid prices) and the enterprise considers cost-quality trade-off in selecting the best human resource for the project; the “Pay-for-use” aspect ensures further productivity for the project. The method ensures optimization of spend and resource utilization for the project. Finally, the compliance-related parameter ensures that the potential human resources have appropriate assessment of their compliance levels with respect to regulatory, industry, trade-association, cybersecurity, legal, best-practices, corporate, and similar knowledge; in case where deficiency is identified, appropriate training or micro-learning can be made available for ensuring the desired proficiency level.

According to aspects of the present disclosure, the project posting can also include required skills and skill-level proficiencies to enable identification of human resources that closely match the requirements.

According to certain aspects herein, the process can involve storing pay-rate history of a human resource for various projects in his/her profile. A pay-rate of the human resource is the human-resource cost to the project. The human resource can use one of the previous rates or a new rate for a new project. For example, if a candidate possesses very high proficiency in a skill that's very difficult to find, s/he can bid a high price for the project requiring that skill. S/he may choose to bid lower rates for the projects that require skills that are easily available from other candidates.

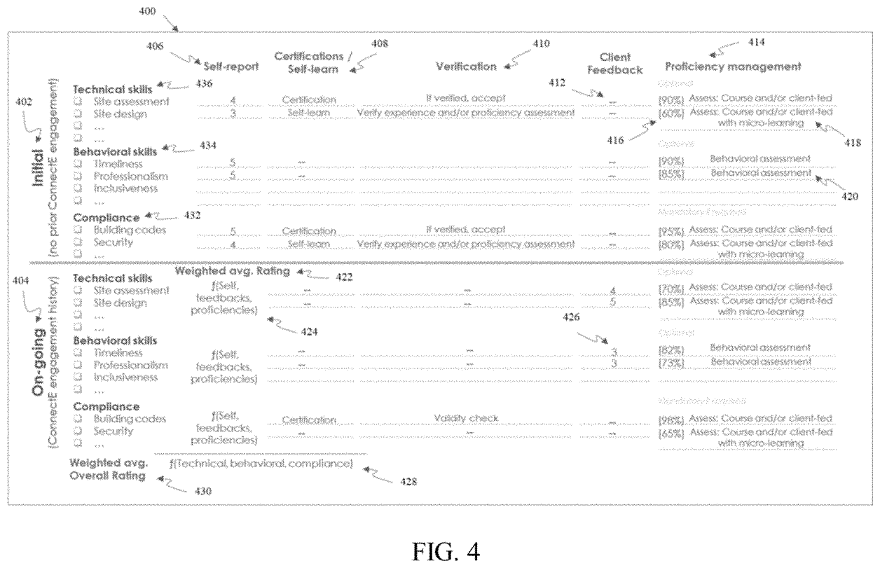

Referring to FIG. 4, in another embodiment of the present invention, the smart workforce management 400 allows human resources with prior 404 and no-prior 402 engagement history with a particular individual or organization to be assessed with respect to technical skills 436, behavioral skills 434, and compliance knowledge/level 432 by building and managing each human resource's (i.e., candidate's) individual profile. The rating for each parameter can be managed by various methods such as, but not limited by, self-reporting 406, certifications/self-learning 408, verification 410 of experiences and credentials, client feedback, proficiency level 416, and proficiency management 414.

According to certain aspects herein, a skill can be at a very granular level in the candidate's profile. An example of the granular level of skill is a candidate's ability to design power amplifier using CMOS MESFET technology at 2.5 GHz using a particular company's semiconductor fabrication process; a higher level of skill is an ability to do RF design; even a higher level of skill is an ability to do analog device.

The technical skills 436 as is known in the art are the abilities and knowledge needed to perform specific tasks which are practical and usually relate to mechanical, information technology, mathematical, electrical or similar scientific tasks (science, technology, engineering, mathematics, arts). Some examples include knowledge of programming languages, mechanical equipment, architectural drawings etc. They are usually acquired over a period of time by an individual through education and/or gaining expertise by performing activities in the related fields.

Some skills can be acquired, refreshed, or enhanced/advanced through micro-learning 418 as well. Micro-learning 418 is a process in which complex topics are broken down into short-term, standalone units of study for a learner, and the units of study are available to view/refer as many times as necessary, whenever and wherever. Micro-learning is most often associated with independent learning, but modules can be strung together to create guided learnings for small groups or individuals.

Compliance 432 is another key factor in selection of candidates. Regulatory compliance, for example, in industrial infrastructure projects generally means complying with a rule/set of rules of the land. These regulations can usually be classified under central, state and local protocols. Some compliance standards are coordinated by industry bodies; Joint Commission issued how medical devices should be managed in a healthcare facility for example. Usually, these regulations are in the form of rules, set of rules, policies specification or laws.

In case of compliance 432, learnings can be acquired, for example, through industry certification programs or micro training by a candidate. In case there is no history 402 available of the candidate, compliance related attributes can be verified 410 by checking certifications; if no certification is available, a candidate's compliance knowledge can be assessed by a computer—generated assessment. If a deficiency is noted, the learning can be provided through micro-training sessions. The micro-learning content can be generated from an industry provided guide, published course, corporate-generated training curriculum or similar other sources. If feedback is available 404 from previous project(s), a candidate's compliance knowledge related information can be extracted from the feedback content. The same is then assessed through appropriate rating.

As is known in the art the behavioral skills 434 are one of the factors used to assess one's performance and attitude. These may differ from organization to organization and the requirement may also vary based on industry sectors. Example of behavioral skills may include communication, conflict resolution, self-improvement, time management, accountability to tasks, responsiveness to requests, professionalism, clear thinking, etc. A very pivotal aspect of behavioral skills 434 is time management. A human resource is often appreciated when s/he is able to manage his/her time between his various projects and delivers the desired outcome on time. Conflict resolution is also an important behavioral skill. Self-improvement is another crucial behavioral skill.

The skills and compliance knowledge proficiency can be assessed from feedback 426 when an engagement history 404 is available. In such a scenario, the rating 424 for a particular skill can be a function of self-assessment, previous client feedback, proficiency management (e.g., gap assessed and courses taken to demonstrate proficiency). The rating can be derived by using a weighted average, another mathematical formula, or an advanced algorithm.

Moreover, the process considers a candidate's self-reported proficiency on a skill when no previous/prior engagement 402 is available. A further weightage is given when the proficiency level is verified. The verification may take place, for example, by evaluating any certification/training, previous work experience, or computer-generated assessment 416. When deficiency is identified 416, an appropriate course or micro-learning sessions 418 can be offered.

Similarly, behavioral skills can be self-reported in the initial phase 402. Once a history 404 is built, previous records and feedback 426 are utilized for the rating.

The overall quality rating of the candidate 430 can be a function 428 of technical behavioral, compliance-related attributes, and the overall rating can be an accumulation of all skill-level ratings of the human resource (i.e., candidate).

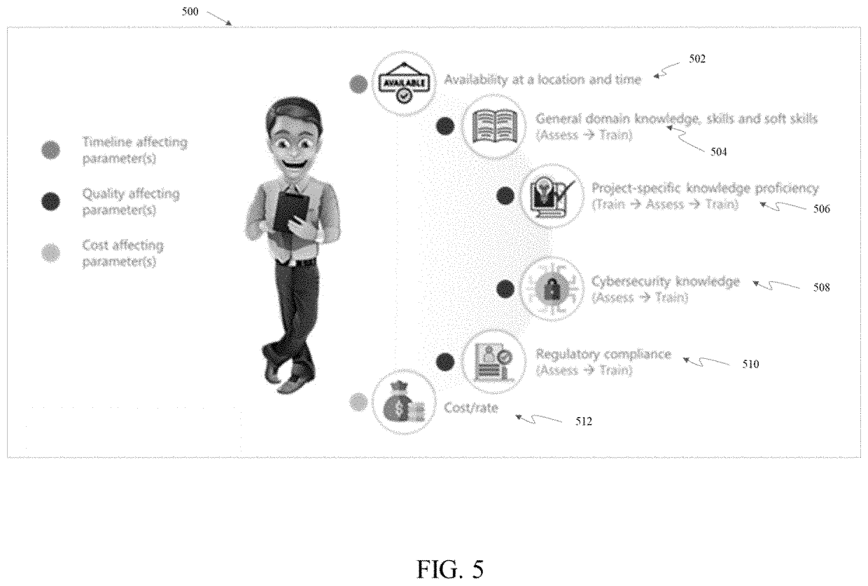

Now, FIG. 5 illustrates an example of engaging 500 a human resource in a particular project according to various embodiments of the present disclosure. The example utilizes parameters such as availability of the candidate (i.e., human resource) at a particular location and time 502 for the desired duration, his/her skills and knowledge in a given domain 504, proficiency in project-specific skills 506, proficiency in cybersecurity 508, proficiency in regulatory compliance 510, and cost/pay-rate 512 of the candidate. The method helps in optimizing cost-, quality-, and timeline-related requirements.

According to various aspects of the present disclosure, the process involves assessing skills in the given domain 504 along with behavioral characteristics. If the skill-levels are assessed to be lower than the desired levels for the chosen candidate, the process involves offering training before engaging in the project. The training can be obtained through a coursework, a practical experiment, micro-learning sessions.

The selected human resource can be trained on specific areas 506 that are critical for quality outcome before engaging in the project. Upon successful training, the proficiency levels in these specific areas can be assessed; if deficiency is found, further training in the area of deficiency can be offered. Similarly, the process involves assessing the candidate on cybersecurity 508 and regulatory compliance 510 knowledge in this example. If the proficiency levels are found to be lower than the desired level for the quality performance, the process involves offering training in those areas before engaging in the project.

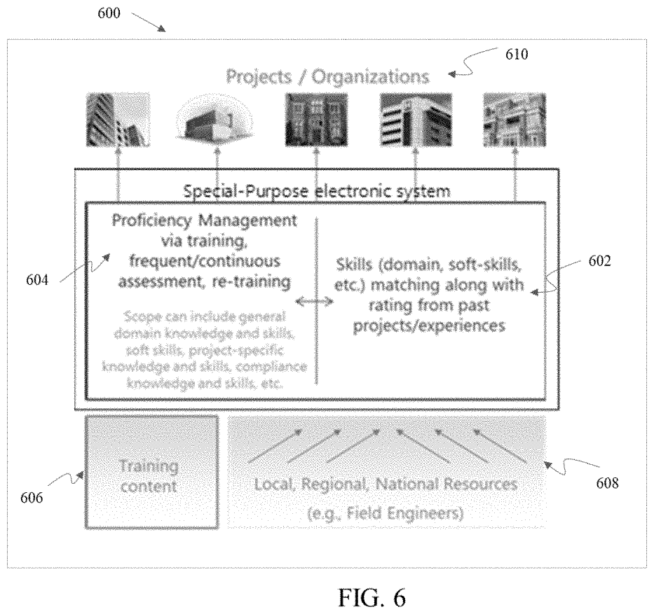

Now FIGS. 5 and 6 reinforce the principle of proficiency management for quality outcome, which can utilize computerized training, frequency/continuous assessment, and re-training not only at the onset of the project but also throughout the life cycle.

Now referring to FIG. 6, a process 600 for sourcing potential candidates (i.e., human resources) 608 to match for various projects from a variety of enterprises 610 and training content 606 to manage proficiency levels 604 in different skills 602 is disclosed via a simple illustration. The skill assessment 604 and training content 606 can be sourced from internal or a variety of external sources such as, but not limited, to corporate curriculum, industry trade organizations, educational institute, consultants, research and development organizations, etc.

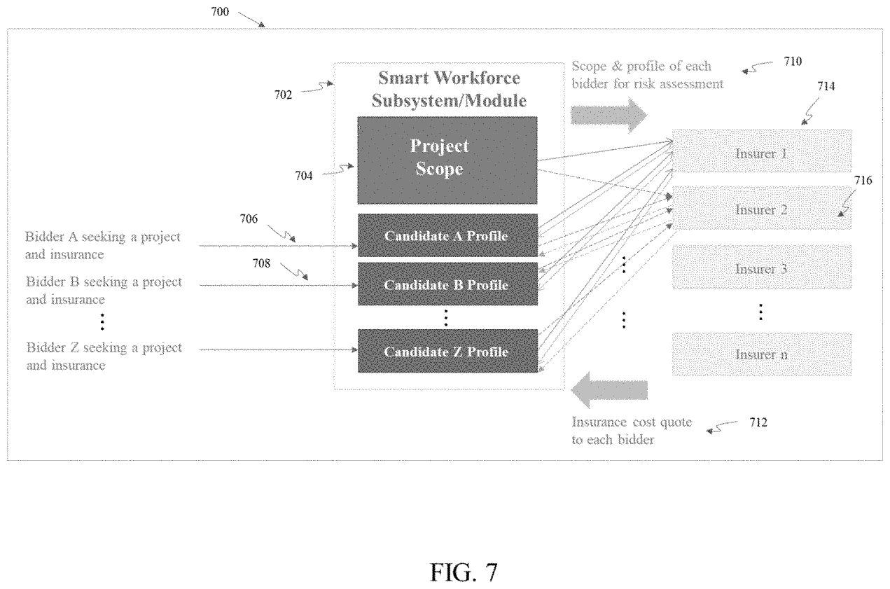

Referring now to FIG. 7, a process 700 for procuring the best insurance policy for human resources is disclosed according to various aspects of the present disclosure. The process involves sharing 710 the scope and working details of the project 704 (e.g., working environment, location, compliance needs, etc.), and profiles of the human resources 706/708, especially the quality ratings to insurance companies 714/716. This information 710 allows the participating insurance companies to understand their risk-reward trade-offs and offering price quotes 712 to each human resource. The rates for each candidate may differ based on the risk profile that considers the scope of the project and the individual candidate's profile.

In a structural engineering project, the basic requirement is of a structural engineer with specific skill-sets to accomplish the prime objective of the project. If the required performance on the project is not met, various liabilities can surface for the organization; hence, the structural engineer must have certain knowledge & certifications. In such a scenario, insurance policy is often required to manage risks and cover potential liabilities. For an insurance company to quote a price, it may need to understand the risk involved in successfully completing the project, which translates to understanding the attributes of the project as well as the attributes of the engaged structural engineer. Different insurance companies may have different risk appetite based on the business priorities, knowledge of the sector, estimation of the risk, internal and external processes, and other similar reasons, and that can lead to different prices. The discussed system thereby brings information transparency to allow insurance companies to estimate and bring out the optimized quotes; it also further allows the prospective engineers to get various quotes, select the best option, and procure the insurance (preferably electronically).

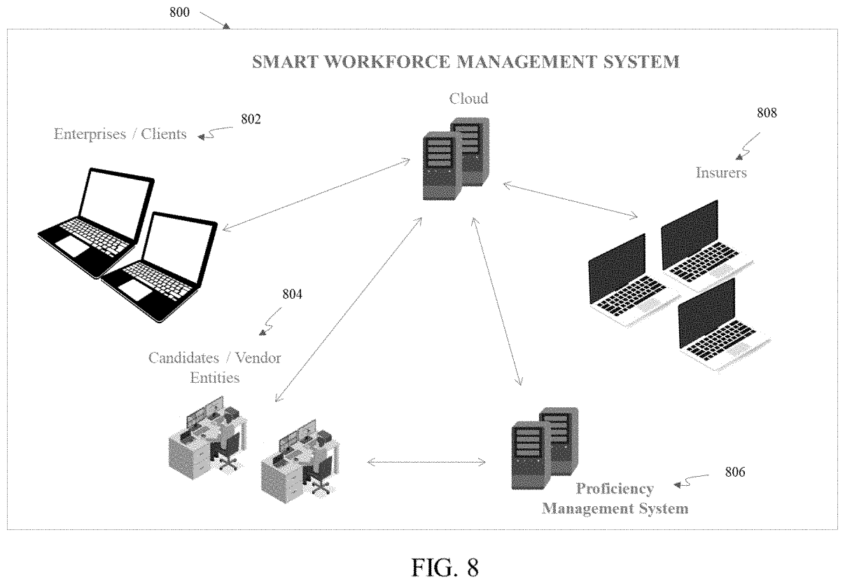

In further embodiment of the proposed invention, the management for the insurance premium/quote involves a respective bidder (human resource) vying for a fit in a project through incorporation of a best-valued insurance module from amongst a panel based on the optimized premium/quotes. In that objective, as illustrated in FIG. 8, the present disclosure can utilize a cloud-computing system that can involve multiple special-purpose subsystems/components and interfaces that connect the enterprises 802, insurers 808, and potential candidates or vendors 804; the proficiency management module 806 can ensure assessments and trainings take place to maintain desired proficiency levels in given skills and compliance areas for the human resources.

According to various aspects of the present disclosure, the process can include third party human resource offering companies (e.g., staffing companies) instead of an individual human resource. In that case, ratings can be maintained at both the company-level and its supplied human-resource-level.

According to certain aspects herein, the process can involve all billings (e.g., to organizations, to candidates, etc.) and payments (e.g., to candidates, to insurance companies, etc.) be performed electronically.

Although the present invention has been described in terms of various embodiments, it is not intended that the invention be limited to these embodiments. Modification within the spirit of the invention will be apparent to those skilled in the art.

Aspects of the present disclosure may be embodied as a system, method, or computer program product. Accordingly, aspects of the present disclosure may take the form of an entirely hardware embodiment, an entirely software embodiment (including firmware, resident software, micro-code, etc.), or an embodiment combining software and hardware aspects. Furthermore, aspects of the present disclosure may take the form of a computer program product embodied in one or more computer readable storage medium(s) having computer readable program code embodied therein.

Any combination of one or more computer readable medium(s) may be utilized. The computer readable medium may be a computer readable signal medium or a computer readable storage medium. A computer readable storage medium may be, for example, but not limited to, a portable computer diskette, a hard disk, a random-access memory (RAM), a read-only memory (ROM), an erasable programmable read-only memory (EPROM), flash memory, a portable computer disc read-only memory (CD-ROM), an optical storage device, a magnetic storage device, or any suitable combination thereof. In the context of this document, a computer readable storage medium may be any tangible medium that can contain, or store a program for use by, or in connection with, an instruction execution system, apparatus, or device. A computer storage medium is not a transient propagating signal, as such.

A computer readable signal medium may include a propagated data signal with computer readable program code embodied therein, for example, in baseband or as part of a carrier wave. A computer readable signal medium is not a computer readable storage medium.

Computer program code for carrying out operations for aspects of the present disclosure may be written in any combination of one or more programming languages. The program code may execute entirely on the user's computer, partly on the user's computer, as a stand-alone software package, partly on the user's computer and partly on a remote computer, or entirely on the remote computer or server.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes and systems for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be apparent to one with skills in the art that the workforce, human resource, risk and insurance management process and system of the invention may be provided using some or all of the mentioned features and components without departing from the spirit and scope of the present invention. It will also be apparent to the skilled artisan that the embodiments described above are specific examples of a single broader invention which may have greater scope than any singular description taught. There may be many alternations made in the descriptions without departing from the spirit of the present invention.

What is claimed is:

1. A computer implemented process for optimizing selection and assignment of a human resource to a project, the process comprising:
creating a profile for each of a plurality of human resources, each profile including one or more parameters indicating availability for work and one or more skills, wherein
the profile includes at least one parameter that uniquely identifies the human resource, at least one parameter that indicates availability, any or a combination of at least one skill and an associated variable that defines proficiency rating, at least one area of compliance achieved, and at least one area of compliance achieved and an associated variable that defines proficiency rating;
generating the proficiency ratings for each of a plurality of skills and compliance areas in the profile based on any or a combination of self-reporting, verification of educational credentials, verification of previous vocational experiences, feedback from previous project engagements, skill assessment results, and training completion;
receiving data indicating a set of criteria for the project, the criteria including at least an estimated schedule and one skill;
receiving a plurality of human resource profiles interested in the project and matching at least one criterion for the project, wherein
the interested human resources submits a pay-rate for engaging in the project;
selecting a human resource based on the project criteria, the human resource profiles and the pay-rates; and
assigning or awarding the project to the selected human resource.

2. The process of claim 1, wherein the human resource is any one of an organizational employee or a contract worker.

3. The computer-implemented process of claim 1 further comprising:
selecting at least one human resource based on the project criteria, the human resource profiles and the pay-rates for assigning the project;
assessing the selected human resources for requirement gaps;
providing training to the selected human resources for fulfilling the requirement gaps based on the assessment;
re-assessing the trained human resources for any one or combination of updated skills and compliance knowledge;
updating the human resource profiles based on the re-assessment results;
selecting a human resource based on the project criteria, the human resource profiles and the pay-rates; and
assigning the selected trained human resource to the project.

4. The process of claim 3, wherein the training is offered through any or combination of a coursework, a practical experiment, and a set of micro-learning sessions.

5. The method of claim 1, wherein the said set of criteria includes at least one parameter from any or a combination of general domain knowledge, project-specific knowledge, behavioral attributes, and compliance knowledge.

6. The method of claim 1, wherein said each of the plurality of human resource profiles includes the identity of the human resource, time durations of availability of human resource to engage in a project, pay-rate, and at least one parameter indicating any or a combination of general domain knowledge, behavioral attributes, and compliance knowledge of a human resource.

7. A computer implemented process for facilitating an insurance policy procurement for a project assignment, the process comprising:
identifying a plurality of human resources seeking project assignments and insurance;
receiving profiles of each of the plurality of human resources, each profile including identity of the human resource, pay-rate, and at least one parameter indicating any or a combination of skills and compliance and respective proficiency level;
receiving data indicating a set of criteria for the project, wherein the criteria include any or a combination of skills, compliance requirements, working conditions and an estimated schedule;
receiving insurance quote for each of the plurality of human resources from at least one insurance company, if an insurance company chose to insure a human resource, based on the profile of the human resource and the criteria of the project;
facilitating selection of an insurance quote; and
facilitating procurement of the selected insurance by enabling contractual transaction.

8. A computer implemented process of claim 7 further comprising:
assessing the plurality of human resources for the project requirement gaps;
providing training to the human resources for fulfilling the requirement gaps based on the assessment;
re-assessing the trained human resources for any one or combination of updated skills and compliance knowledge;
updating the human resource profiles based on the re-assessment results; and
updating the insurance quotes based on the updated human resource profiles.

9. A computer implemented process for optimizing selection and assignment of a human resource to a project, the process comprising:
one or more processors, one or more computer-readable memories, one or more computer-readable tangible storage devices and program instructions which are stored on at least one of the one or more storage devices for execution by at least the one or more processors via at least one of the one or more memories, the program instructions comprising:
creating a profile for each of a plurality of human resources, each profile including one or more parameters indicating availability for work and one or more skills, wherein
the profile includes at least one parameter that uniquely identifies the human resource, at least one parameter that indicates availability, any or a combination of at least one skill and an associated variable that defines proficiency rating, at least one area of compliance achieved, and at least one area of compliance achieved and an associated variable that defines proficiency rating;
generating the proficiency ratings for each of a plurality of skills and compliance areas in the profile based on any or a combination of self-reporting, verification of educational credentials, verification of previous vocational experiences, feedback from previous project engagements, skill assessment results, and training completion;
receiving data indicating a set of criteria for the project, the criteria including at least an estimated schedule and one skill;
receiving a plurality of human resource profiles interested in the project and matching at least one criterion for the project, wherein
the interested human resources submits a pay-rate for engaging in the project;
selecting a human resource based on the project criteria, the human resource profiles and the pay-rates; and
assigning or awarding the project to the selected human resource.

10. The computer system of claim 9, wherein the human resource is any one of an organizational employee or a contract worker.

11. The system of claim 9, wherein the program instructions comprising:
selecting at least one human resource based on the project criteria, the human resource profiles and the pay-rates for assigning the project;
assessing the selected human resources for requirement gaps;
providing training to the selected human resources for fulfilling the requirement gaps based on the assessment;
re-assessing the trained human resources for any one or combination of updated skills and compliance knowledge;
updating the human resource profiles based on the re-assessment results;
selecting a human resource based on the project criteria, the human resource profiles and the pay-rates; and
assigning the selected trained human resource to the project.

12. The computer system of claim 11, wherein the training is offered through any or combination of a coursework, a practical experiment, and a set of micro-learning sessions.

13. The computer system of claim 9, wherein the said set of criteria includes at least one parameter from any or a combination of general domain knowledge, project-specific knowledge, behavioral attributes, and compliance knowledge.

14. The computer system of claim 9, wherein said each of the plurality of human resource profiles includes the identity of the human resource, time durations of availability of human resource to engage in a project, pay-rate, and at least one parameter indicating any or a combination of general domain knowledge, behavioral attributes, and compliance knowledge of a human resource.

15. The computer system of claim 9, wherein the program instructions comprising:
receiving data indicating a detailed set of criteria for the project, wherein the detailed criteria include any or a combination of skills, compliance requirements, working conditions and an estimated schedule;
receiving insurance quote for each of the plurality of human resources from at least one insurance company, if an insurance company chose to insure a human resource, based on the profile of the human resource and the detailed criteria of the project;
facilitating selection of an insurance quote; and
facilitating procurement of the selected insurance by enabling contractual transaction.

16. The computer system of claim 15, wherein the program instructions comprising:
assessing the plurality of human resources for the project requirement gaps;
providing training to the human resources for fulfilling the requirement gaps based on the assessment;
re-assessing the trained human resources for any one or combination of updated skills and compliance knowledge;
updating the human resource profiles based on the re-assessment results; and
updating the insurance quotes based on the updated human resource profiles.
